(19) United States
(12) Patent Application Publication
(10) Pub. No.: US 2005/0195788 A1
(43) Pub. Date: Sep. 8, 2005

(54) Electronic messaging system and associated method for sending electronic messages

(76) Inventors: Eric Villain, Saint Martin D'Heres (FR); Alain Prola, Grenoble (FR); Fabrice Tran Xuan, Eybens (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 11/004,626

(22) Filed: Dec. 3, 2004

(30) Foreign Application Priority Data
Dec. 3, 2003 (FR) FR 0314178

(51) Int. Cl. H04Q 7/28

(52) U.S. Cl. 370/341

(57) ABSTRACT

A method for sending electronic messages via a messaging system that includes receiving, by a group messaging server, a message sent from a remote user's terminal; and transmitting the message by the group messaging server to the terminals of users in a group of predetermined users according to transmission rules predetermined by the user at whose initiative the group of users is created.

### BACKGROUND OF THE INVENTION

1. Field of the Invention

The invention relates to the generation and transmission of electronic messages and more specifically relates to a method and a system of electronic messaging that can be used to generate and transmit electronic messages between several communicating parties.

2. Description of the Relevant Art

The growing use of electronic messaging, particularly in an inter-company environment, creates for each user a proliferation of received mail which is difficult for users to manage.

This problem is more pronounced when electronic mails are exchanged between several communicating parties and when each user wishes to share their comments with the other communicating parties, but also wishes to be kept informed of contributions by other members. Electronic messaging services offer a “reply to all” function which, when used, creates a large number of electronic messages.

Therefore it is an aim of the described embodiments to overcome this drawback and provide a system and a method of electronic messaging that can manage messages and do so at the source, i.e. before they are sent, in order to limit the number of electronic mails to be routed.

### SUMMARY OF THE INVENTION

According to one embodiment, there is therefore proposed, in accordance with a first aim, an electronic messaging system including a set of networked electronic message sending and receiving servers for sending and receiving messages and, through use of these servers, computer equipment of remote users communicate.

According to a general feature of this system, the system additionally includes a group messaging server via which messages flow between the sending and receiving servers, the said group messaging server organizing and distributing messages among a group of predetermined users according to transmission rules predetermined by a user at whose initiative the group of users is created.

Thus, the contributors and the initiator do not reply to all the members, but only to the group server which organizes the replies and distributes them according to the rules indicated by the initiator.

Since a limited group of communicating parties is created and since the message sending arrangements and content are managed at the source, the number of electronic mails can be limited considerably without restricting the quantity of information transmitted. Due to the way messages are organized, all redundancies can be avoided while maintaining temporal consistency of messages. Furthermore, since mail is managed in a centralized way by a group server, the invention can be easily incorporated into pre-existing electronic messaging architectures.

In one embodiment, the group messaging server includes means for checking the identity of each user in the messaging group.

In one embodiment, these checking means include a module for generating encryption keys intended to be transmitted respectively to the users in the group in a messaging session-opening message and to be inserted in messages sent by these users to check their identities.

These checking means may additionally include means for generating an authenticator for a user at whose initiative the group of users is created in order to authenticate that user during the creation of the messaging session.

In an embodiment, the system additionally includes a database for storing messages and parameters of each messaging session.

To manage the messages, the system additionally includes a management module intended to periodically query the database in order to monitor the progress of the messaging session and to program the sending of electronic messages when one or more predetermined criteria are fulfilled, and a message formatting module controlled by the management module to generate a message destined for users in the group according to the said transmission rules.

According to another aim, there is proposed a method for sending electronic messages via a messaging system as defined above, which method includes: sending of a message from a terminal of a remote user; reception of the message by the group messaging server; and transmission of the said message by the group messaging server to the terminals of users in a group of predetermined users according to transmission rules predetermined by the user at whose initiative the group of users is created.

According to another feature of the method, a preliminary phase for configuring a messaging session is provided. This phase includes: a step for the transmission, by the group server to the terminal of the user at whose initiative the group of users is created, of a configuration form for the session; a step for filling in the form such that electronic addresses of the users in the group of users, access rights of each user and additional information relating to the progress of the session are specified; a step for sending the completed form to the group server; a step for determining an authenticator for each user in the group; a step for storing the information contained in the form in a database; and a step for sending a session-opening electronic mail to each user in the group, the said electronic mail containing information extracted from the form and the authenticator of the user.

Advantageously, during the session, the database is periodically queried to monitor the progress of the session, a session report is produced for each user in the group of users according to predetermined setup criteria and the report is transmitted to each user, the said report containing the messages received from at least some of the terminals of users in the group.

### BRIEF DESCRIPTION OF THE DRAWINGS

Other aims, features and advantages of the invention will become apparent on reading the following description, given only by way of non-limiting example and with reference to the accompanying drawings in which:

FIG. 1 is a block diagram illustrating the general architecture of an electronic messaging system;

FIG. 2 is a block diagram detailing the architecture of the group server of the messaging system in FIG. 1; and

FIG. 3 is a flow chart illustrating the operation of the system in FIG. 1.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

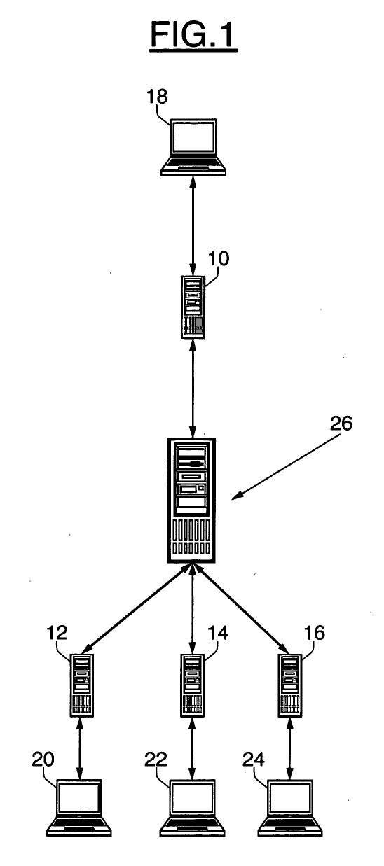

With reference to FIG. 1, an electronic messaging system includes a set of networked message sending and receiving servers, such as 10, 12, 14 and 16. These messaging servers may be made up of all types of appropriate sending and receiving servers, such as POP (Post Office Protocol) or IMAP (Internet Message Access Protocol) servers, each being used to send an electronic message to a remote messaging server and to render the received messages to the user. Indeed, as FIG. 1 shows, these messaging servers 10, 12, 14 and 16 communicate with remote user computer equipment 18, 20, 22 and 24, made up of conventional microcomputers.

In one embodiment, the network illustrated in FIG. 1 is equipped with a group messaging server 26 communicating with the set of sending and receiving servers 10, 12, 14 and 16 to manage communications between these latter.

More specifically, the group messaging server 26 is used to create, within the network, a restricted group of members at the initiative of one of the users, e.g. the user labeled 18, in order to manage communications between the users in this group and to organize the messages between these users.

As will be described in detail later, this group messaging server 26 can be remotely programmed to define the users in the group and the access rights of each user. It can also be configured so as to program the sending of session reports when one or more predetermined criteria are fulfilled and distribute these reports to all the members, and all this is done according to transmission rules specified for each user, defining in particular their access rights.

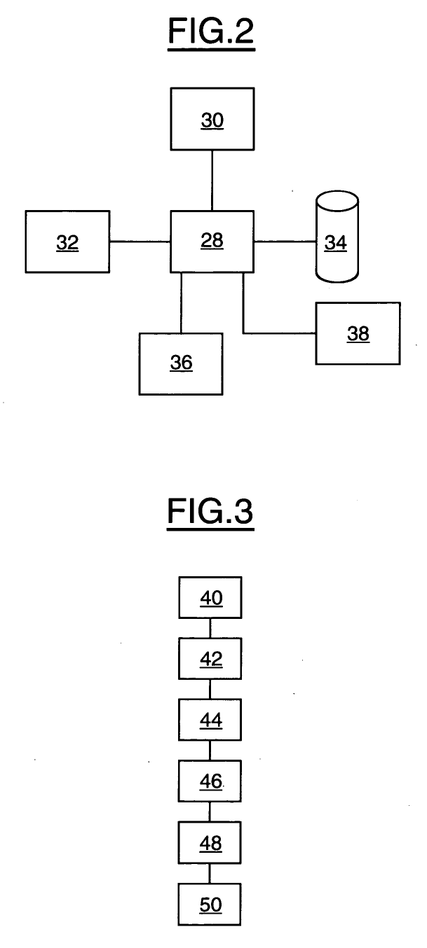

As FIG. 2 shows, the server 26 is structured around a central processing unit 28 and includes an actual messaging server 30 for sending and receiving messages destined for messaging servers 10, 12, 14 and 16 of the system. The central processing unit 28 is also linked to an encryption module 32 for generating encryption keys to check the identity of each user.

A database 34 is used to store all the parameters of each messaging session programmed by the user 18 at whose initiative the messaging group is formed.

In addition, a management module 36 periodically monitors the progress of a messaging session that is under way, particularly for detecting the fulfillment of one or more predetermined criteria.

Lastly, a session report generation module 38 is connected to the central processing unit 28. This module 38 is used to generate the session reports according to information relating to the members, which is extracted from the database 34, and additional information relating to the progress of the session and specifying the content of the report.

With reference to FIG. 3, the system just described operates in the following way. As before, in the following part of the description it will be assumed that the session is created at the initiative of the computer equipment labeled 18. The first phase for creating the restricted group of users begins with the sending of a standard electronic mail to the group messaging server 26. Clearly, this message is routed to this server 26 via the messaging server 10. Within the group server 26, this message is received by the actual messaging server 30. The central processing unit 28, which regularly queries the messaging system, then detects the messages without specific information. Such messages are identified as being session-opening requests (step 40).

At the next step 42, an authenticator is determined by the central processing unit 28 based on the wording in the sender's electronic address extracted from the received electronic mail and on a session number. A session configuration form is then transmitted to the requesting user together with the authenticator. This configuration form appears for example as an interface having a set of fields to be filled in by the user for specifying all the electronic addresses of the users in the group to be created, access rights of each user (such as consultation rights, reply rights, etc.), criteria for generating session reports, and parameters relating to how messages are presented in this report. The form also contains additional information relating to the content of the session in the form of a session title, a description of a subject to be discussed between the group members, a maximum duration specified for the session, etc.

After the group server 26 has received the form, the session information is recorded in the database 34 (step 44). Authenticators are then determined for each member, based on the wording of the electronic address of each member and on the session number. These authenticators are henceforth valid for one session only.

At the next step 46, the group server 26 generates a session-opening message for each member. This message indicates the opening of the session with the title, the description of the subject to be discussed and the duration of the session. An attachment containing an encrypted key delivered by the encryption module 32 is associated with this opening message so that each user and the session to which they belong can be identified unambiguously, when that user replies to this opening message.

At the next step 48, electronic mails are then exchanged freely between the users. Note however that the replies are centralized by the group server 26 and are sorted and stored in the database 34. During the session, the management module 36 periodically queries the database in order to register newly created parameters of sessions, and at the same time monitors the progress of the arrival of messages. When a predetermined criterion is fulfilled, e.g. a reply from all the members or when a special control message is received from the user or when a predetermined period of time elapses, the management module 36 prompts the session report generation module 38 (step 48). This module 38 then retrieves the information relating to the members and generates the report according to the choices expressed at the enrollment stage, which choices apply to the generation of this report, in order that the presentation of the messages is aligned with the criteria specified by the user at whose initiative the group is formed. Thus, for example, the messages can be sorted by date or by sender. Provision can also be made to send a final result corresponding to the last electronic mail received. After the session reports are generated, they are sent to all the members (step 50).

At the same time, during this step 50, the management module 36, which monitors the progress of the session, checks for the appearance of a predetermined criterion on the basis of which it is decided that the session must come to a close. For example, this criterion may be the reception of a specific message, the result of a vote by the members, or the expiry of a time limit for the session. When such a criterion is fulfilled, the module 38 generates a final report in order to transmit to each user in the group the final decision of all the members.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. A method for sending electronic messages via a messaging system comprising at least one group messaging server, the method comprising receiving by the group messaging server a message sent from a remote user's terminal; and transmitting the said message by the group messaging server to the terminals of users in a group of predetermined users according to transmission rules predetermined by the user at whose initiative the group of users is created.

2. The method according to claim 1, further comprising: configuring a messaging session; transmitting, by the group server to the terminal of the user at whose initiative the group of users is created, a configuration form for the session; receiving by the group server the configuration form filled in such that electronic addresses of the users in the group of users are specified; and storing the information contained in the form in a database.

3. The method according to the claim 2, wherein during the session: the group messaging server periodically queries the database to monitor the progress of the session; produces a session report for each user in the group of users according to predetermined setup criteria; and transmits the report to each user, the said report containing the messages received from at least some of the terminals of users in the group.

4. An electronic messaging system comprising:
a set of networked electronic message sending and receiving servers configured for sending and receiving messages and with which servers computer equipment of remote users communicate, and
a group messaging server via which messages flow between the sending and receiving servers, the said group messaging server organizing and distributing messages among a group of predetermined users according to transmission rules predetermined by a user at whose initiative the group of users is created.

5. The messaging system according to claim 4, wherein the group messaging server comprises means for checking the identity of each user in the messaging group.

6. The messaging system according to claim 5, wherein the checking means comprises a module for generating encryption keys intended to be transmitted respectively to the users in the group in a messaging session-opening message and to be inserted in messages sent by these users to check their identities.

7. The messaging system according to claim 5, wherein the checking means comprises means for generating an authenticator for the user at whose initiative the group of users is created in order to authenticate that user during the creation of the messaging session.

8. The messaging system according to claim 4, further comprising a database for storing messages and parameters of each messaging session.

9. The messaging system according to claim 8, further comprising:
a management module intended to periodically query the database in order to monitor the progress of the messaging session and to program the sending of electronic messages when one or more predetermined criteria are fulfilled; and
a message formatting module controlled by the management module to generate a message destined for users in the group according to the said transmission rules.

10. A group messaging server, comprising: a central processing unit; a messaging module for receiving messages from other messaging servers; a database for storing remotely programmable messaging session parameters; and a module for managing the progress of a messaging session in conjunction with the database and the messaging module.

11. A computer program product that can be loaded directly into an internal memory of a group messaging server, the computer program product comprising portions of software code for executing a method when the program is run on the messaging server, wherein the method comprises:
receiving by the group messaging server a message sent from a remote user's terminal;
and transmitting the said message by the group messaging server to terminals of users in a group of predetermined users according to transmission rules predetermined by the user at whose initiative the group of users is created.

12. A computer readable medium that can be used in a group messaging server and on which is stored a computer program product that can be loaded directly into an internal memory of the group messaging server, wherein the computer program product comprises portions of software code for executing a method when the program is run on the group messaging server, wherein the method comprises:
receiving by the group messaging server a message sent from a remote user's terminal;
and transmitting the said message by the group messaging server to terminals of users in a group of predetermined users according to transmission rules predetermined by the user at whose initiative the group of users is created.
